(19) United States
(12) Patent Application Publication
(10) Pub. No.: US 2010/0282411 A1
(43) Pub. Date: Nov. 11, 2010

(54) POLYAMIDES

(75) Inventors: Tina Nataniel, Saint Charles, IL (US); Dwight D. Heinrich, Aurora, IL (US)

Correspondence Address: Loctite Corporation, One Henkel Way, Rocky Hill, CT, 06067, US

(73) Assignee: Henkel Corporation, Rocky Hill, CT (US)

(21) Appl. No.: 12/839,766

(22) Filed: Jul. 20, 2010

Related U.S. Application Data
(63) Continuation of application No. PCT/US2009/000335, filed on Jan. 20, 2009.
(60) Provisional application No. 61/022,398, filed on Jan. 21, 2008.

(51) Int. Cl. C08G 69/26; B32B 37/12

(52) U.S. Cl. 156/331.8; 528/335

(57) ABSTRACT

Solvent-resistant polyamides having an exceptionally desirable combination of properties, including good cold flexibility, excellent impact resistance and high heat resistance are obtained by reacting a) an acid component comprising at least one C₆ to C₂₂ aliphatic dicarboxylic acid and b) an amine component comprising at least one alkylene diamine having from 2 to 14 carbon atoms, at least one polyoxyalkylene diamine containing at least one polyoxytetramethylene block, and at least one polyoxyalkylene diamine that does not contain a polyoxytetramethylene block. Such polyamides are particularly useful for molding and bonding applications, such as, for example, in the filter industry, especially articles that are to be used in applications involving organic solvents, fuels or oils.

### FIELD OF THE INVENTION

The invention relates to polyamides based on C₆ to C₂₂ aliphatic dicarboxylic acids, alkylene diamines having from 2 to 14 carbon atoms, polyoxyalkylene diamines containing at least one polyoxytetramethylene block, and polyoxyalkylene diamines that do not contain polyoxytetramethylene blocks.

### SUMMARY OF THE INVENTION

The present invention provides solvent resistant polyamides having an exceptionally desirable combination of properties, including good cold flexibility, excellent impact resistance and high heat resistance. The polyamides are formed by reacting a) an acid component comprising at least one C₆ to C₂₂ aliphatic dicarboxylic acid and b) an amine component comprising at least one alkylene diamine having from 2 to 14 carbon atoms, at least one polyoxyalkylene diamine containing at least one polyoxytetramethylene block, and at least one polyoxyalkylene diamine that does not contain a polyoxytetramethylene block. The polyamides of the invention are particularly useful for bonding applications, such as, for example, in the filter industry, especially articles that are to be used in applications involving organic solvents, fuels or oils.

### DETAILED DESCRIPTION OF CERTAIN EMBODIMENTS OF THE INVENTION

The polyamides of the present invention exhibit hot melt adhesive properties. That is, they are essentially nontacky at room temperature, tacky when heated, and exhibit adhesive bond strength. In certain embodiments, the polyamides exhibit a Shore D hardness as measured by ASTM D2240-85 of from about 65 to 85 or about 70 to about 80. The viscosities of the polyamides may vary, for example, from about 40 to about 150 poise at 225° C., as measured by ASTM D3236-88 (spindle 27). The softening points of the polyamides may, in certain embodiments of the invention, be at least about 190° C. or at least about 195° C. or at least about 200° C., as measured by ASTM E28-99.

The acid component used to prepare the polyamide contains one or more aliphatic dicarboxylic acids containing from 6 to 22 (in one embodiment, 8 to 18, in another embodiment, 10 to 14) carbon atoms. Linear as well as branched aliphatic dicarboxylic acids may be employed. Suitable aliphatic dicarboxylic acids for use in the present invention include, but are not limited to, compounds corresponding to the general formula HOOC—R₁—COOH where R₁ is a divalent, aliphatic, hydrocarbon radical having from 5 to 21 (in one embodiment, 7 to 17, in another embodiment, 9 to 13) carbon atoms such as azelaic acid, sebacic acid (also known as octanedicarboxylic acid or 1,10-decanedioic acid), 1,12-dodecanedioic acid (also known as decanedicarboxylic acid), 1,14-tetradecanedioic acid (also known as dodecanedicarboxylic acid), 1,16-hexadecanedioic acid (also known as tetradecanedicarboxylicacid), 1,18-octadecanedioic acid (also known as hexadecanedicarboxylic acid) and mixtures thereof. R₁ may be straight chain or branched. One or more acids selected from the group consisting of 1,10-decanedioic acid, 1,12-dodecanedioic acid and 1,14-tetradecanedioic acid may comprise at least 50 mole % (in another embodiment, at least 80 mole %; in yet another embodiment, at least 90 mole %) of the aliphatic dicarboxylic acid(s) used. In another embodiment, the acid component used to prepare the polyamide consists essentially of 1,10-decanedioic acid, or 1,12-dodecanedioic acid, or 1,14-tetradecanedioic acid or mixtures of two or more of these acids.

The amine component is comprised of at least one alkylene diamine having from 2 to 14 carbon atoms, at least one polyoxyalkylene diamine containing at least one polyoxytetramethylene block, and at least one polyoxyalkylene diamine that does not contain a polyoxytetramethylene block. Other types of amines may optionally also be present in the amine component. However, the aforementioned three specific types of amines in one embodiment together comprise at least 50 mole % (in another embodiment, at least 80 mole %; in yet another embodiment, at least 95 mole %) of the amine component. In still another embodiment, the amine component consists essentially of one or more alkylene diamines having from 2 to 14 carbon atoms, at least one polyoxyalkylene diamine containing at least one polyoxytetramethylene block, and at least one polyoxyalkylene diamine that does not contain a polyoxytetramethylene block.

Using one or more alkylene diamines in the preparation of the polyamide has been found to both increase the hardness of the resulting polyamide as well as improve its heat resistance. The alkylene diamine in one embodiment corresponds to the formula:

H₂N—(CHR)ₙ—NH₂

where “n” is 2 to 14 (in certain embodiments, 2 to 10 or 4 to 8), and R is hydrogen or lower (e.g., C₁-C₄) alkyl. The R groups within a single molecule may be the same or different. Straight chain alkylene diamines (where all R groups are H) are used in one embodiment of the invention, although branched chain alkylene diamines (where at least one R is an alkyl group) could also be used (either alone or in combination with one or more straight chain alkylene diamines). Thus, illustrative non-limiting examples of useful alkylene diamines include ethylenediamine, 1,2-propylenediamine, 1,3-propylenediamine, tetramethylenediamine, pentamethylenediamine, hexamethylenediamine, octamethylenediamine, decamethylenediamine, 2-methyl-1,5-pentanediamine, 5-methyl-1,9-nonanediamine, dodecamethylenediamine, tetradecamethylenediamine and trimethylhexamethylenediamine and mixtures thereof. Especially useful polyamides are obtained in accordance with this invention when the alkylene diamine used is predominately (e.g., greater than 50 mole %; in another embodiment greater than 80 mole %) or entirely hexamethylenediamine.

The amine component is further comprised of at least two different polyoxyalkylene diamines. At least one of the polyoxyalkylene diamines contains a polyoxytetramethylene block, while at least one of the polyoxyalkylene diamines does not contain such a polyoxytetramethylene block. The former type of polyoxyalkylene diamine has been found to help improve the cold flexibility of the polyamide while also maintaining solvent resistance, while the latter type of polyoxyalkylene diamine can render the polyamide transparent and/or enhance the compatibility of the various components of the polyamide. The polyoxyalkylene diamine reactants generally contain two amine groups, which may be primary or secondary, and a polyether chain, with an amine group preferably at each end of the polyether chain.

Illustrative non-limiting examples of useful non-polyoxytetramethylene block-containing polyoxyalkylenediamines have the structural formula:

H₂N—CH(R²)CH₂—R¹—O—CH₂CH(R²)—NH₂

wherein:

R¹ represents a polyoxyalkylene chain having the structural formula:

(O—CH₂—CH₂—)ₐ—(O—CH₂—CH(R³))_{b}

wherein:

R³ is a monovalent organic radical selected from the group consisting of C1 to C4 aliphatic hydrocarbons, ‘a’ designates a number of ethoxy groups (O—CH₂—CH₂), ‘b’ designates a number of monosubstituted ethoxy groups (O—CH₂—CH(R³)), the sum of ‘a’ and ‘b’ is equal to or greater than 1 but less than or equal to 300, provided that for any values of a and b the sequence of ethoxy and monosubstituted ethoxy groups within a polyoxyalkylene chain may be completely random and/or there may be blocks of ethoxy and/or monosubstituted ethoxy groups, and R² designates hydrogen or a monovalent organic radical selected from the group consisting of C1 to C4 aliphatic hydrocarbons.

Illustrative non-limiting examples of useful polyoxytetramethylene block-containing polyoxyalkylenediamines have the structural formula:

H₂N—X—Y—X¹—NH₂

wherein X and X¹ are the same or different and are comprised of oxyalkylene groups selected from the group consisting of oxyethylene (—OCH₂CH₂—), oxypropylene (—OCH₂CH(CH₃)—), oxybutylene (—OCH₂CH(CH₂CH₃)—) and combinations thereof (preferably from about 1 to about 5 such oxyalkylene groups, it being understood that the moiety adjacent to one of the —NH₂ groups may be an alkylene group such as ethylene or propylene as a result of a hydroxyl group being converted into an amino group), and Y is comprised of oxytetramethylene groups (—OCH₂CH₂CH₂CH₂—) (preferably from about 5 to about 20 oxytetramethylene groups). Polytetramethylene glycols having number average molecular weights of from about 500 to about 2000 (e.g., about 700 to about 1500) which are end-capped with two or more (e.g., three to 15) moles of an alkylene oxide such as ethylene oxide and/or propylene oxide per mole of polytetramethylene glycol, with the terminal hydroxyl groups thereafter converted to amino groups, are especially useful in the present invention. In particular, polyoxytetramethylene block-containing polyoxyalkylenediamines having the following structural formula can be used:

H₂NCH(R²)CH₂-[OCH(R²)CH₂]ₘ—[OCH₂CH₂CH₂CH₂]ₙ—[OCH₂CH(R²)]ₚNH₂

wherein R² designates hydrogen or methyl, m is 0 to 4 (e.g., 1 to 3), n is 5 to 20 (e.g., 8 to 15), and p is 1 to 5 (e.g., 2 to 4).

Techniques for preparing suitable polyoxyalkylene diamines are known in the art, and include reacting an initiator containing two hydroxyl groups with ethylene oxide and/or monosubstituted ethylene oxide (e.g., propylene oxide, butylene oxide) followed by conversion of the resulting terminal hydroxyl groups to amines. Where the polyoxyalkylene diamine produced contains a polyoxytetramethylene block, the initiator used may be a polytetramethylene glycol. Illustrative of the polyoxyalkylene diamine reactants employed in the invention are the JEFFAMINE brand of polyoxyalkylene diamines available from Huntsman Corporation, Houston, Tex. These polyoxyalkylene diamines are prepared from reactions of bifunctional initiators with ethylene oxide and propylene oxide followed by conversion of terminal hydroxyl groups to amines. Especially suitable polyoxyalkylene diamines include the JEFFAMINE D-series and XTJ-series polyoxyalkylene diamines from Huntsman Chemical Company. The D-series polyoxyalkylene diamines do not contain polyoxytetramethylene blocks while certain of the XTJ-series polyoxyalkylene diamines do contain such blocks (e.g., XTJ-542, which is believed to have a center block containing about 9 oxytetramethylene groups on average along with an average of about 2.5 oxypropylene groups on either end of the polyoxytetramethylene block, and XTJ-559, which is believed to have a center block containing about 14 oxytetramethylene groups on average along with an average of about 3 oxypropylene groups on either end of the polyoxytetramethylene block). The polyoxyalkylene diamines utilized in the present invention may, for example have number average molecular weights between about 230 and about 6,000, in another embodiment having number average molecular weights from about 300 to about 5,000. In a preferred embodiment of the invention, the non-polyoxytetramethylene block-containing polyoxyalkylene diamine is relatively low in molecular weight, e.g., from about 300 to about 600 number average molecular weight. In another preferred embodiment, the polyoxyalkylene diamine that does contain a polyoxytetramethylene block has a number average molecular weight of from about 500 to about 2000. In one embodiment, the non-polyoxytetramethylene block-containing polyoxyalkylenediamine(s) used contain(s) only oxypropylene groups, i.e., those polyoxyalkylenediamines of the above formula wherein “a” is zero and R³ is methyl.

In one embodiment, the amine component used to prepare the polyamide is comprised of 75 to 94 equivalent % alkylene diamine having from 2 to 14 carbon atoms, 1 to 10 equivalent % polyoxyalkylene diamine containing at least one polyoxytetramethylene block, and 5 to 15 equivalent % polyoxyalkylene diamine that does not contain a polyoxytetramethylene block. In another embodiment, the equivalent ratio of C2-C14 alkylene diamine:polyoxyalkylene diamine that does not contain a polyoxytetramethylene block is from about 5:1 to about 12:1. In another embodiment, the equivalent ratio of C2-C14 alkylene diamine:polyoxyalkylene diamine containing a polyoxytetramethylene block is from about 10:1 to about 20:1. In still another embodiment, the equivalent ratio of C2-C14 alkylene diamine to polyoxyalkylene diamine (of any structure) is from about 3:1 to about 8:1. The equivalent ratio of polyoxyalkylene diamine that does not contain a polyoxytetramethylene block to polyoxyalkylene diamine that does contain a polyoxytetramethylene block can be from about 0.8:1 to about 2.5:1, in one embodiment of the invention.

The number of free acid groups and/or free amine groups present in the polyamide are directly related to the relative amounts of the acid component and amine component involved in the polymerization reaction and the degree of completion of the reaction. The polyamide may be either acid-terminated, amine-terminated, or contain both acid and amine terminal groups. Generally speaking, polyamides in accordance with the invention that are acid-terminated tend to have better stability at elevated temperatures than the corresponding amine-terminated polyamides. However, the amine-terminated polyamides tend to exhibit better adhesion to substrate surfaces. Approximately stoichiometric amounts (e.g., a ratio of total acid to total amine groups of from about 0.9:1 to about 1.1:1, more typically from about 0.95:1 to about 1.05:1) based on the total number of available acid and amine groups may be used to prepare the polyamide resins of this invention and the reaction conditions can be selected to ensure completion or substantial completion of the amidation (condensation) reaction.

In one embodiment of the invention, the polyamide may be the result of as complete an amidation reaction as possible between the starting acid component and the amine component. Those skilled in the art will recognize that the degree of completion of the amidation process can be determined by evaluating the acid number and the amine number of the final polymer. The polyamide may have relatively low acid and amine numbers, typically less than about 40 in total, more typically less than about 25 in total, and even more typically less than about 20 in total.

The reaction mixture used to prepare the polyamide may optionally include one or more chain terminators, which may assist in controlling the molecular weight achieved during the condensation polymerization and/or affect the structure of the end groups present in the polymer chain. Useful chain terminators include acids such as monocarboxylic acids (e.g., fatty acids such as stearic acid and hexadecanoic acid) and bases such as monoamines (e.g., benzyl amine, hexylamine, octadecylamine).

The instant polyamides may be prepared using conventional procedures and reaction conditions known to the art. It should be noted that while reference is made to acid and amine components for purposes of determining the relative amounts of each acid and amine used to prepare the polyamide, there is no need to form a separate premix of acids and a separate premix of amines, nor is it required that all reactants be charged together at the beginning of the reaction. In general, the acid and amine components may be reacted until the final product has an acid value and an amine value less than 25 (in another embodiment, less than 20), with the reaction being generally conducted at temperatures from about 100° C. to about 300° C. for from about 1 to about 8 hours. Most often the reactions will be heated from 140° to 240° C. until approximately the theoretical amount of water is evolved. Generally several hours are required to complete the reaction. The reaction is preferably conducted under an inert atmosphere, such as nitrogen, and during the final stages of the reaction a vacuum is applied to the system to facilitate removal of the final traces of water and any other volatile materials. The use of catalysts, particularly phosphorus-containing catalysts such as phosphoric acid, hypophosphoric acid, sodium benzene phosphonate, or sodium benzene phosphinate, and/or vacuum can be used, especially in the latter part of the reaction, to yield a more complete amidation reaction and/or accelerate the rate of condensation polymerization.

The polyamides obtained by the aforedescribed procedures may be used without further modification. The polyamide compositions of this invention may, however, be combined or modified with conventional additives widely known and used in the resin arts. For example, thermal stabilizers, antioxidants, UV stabilizers, plasticizers, nucleating agents, impact modifiers, tackifiers, flame retardants, corrosion inhibitors, antistatic agents, reinforcing agents, processing aids including mold release agents, lubricants and the like, as well as pigments, dyes, inorganic or organic fillers such as carbon black, talc, clay, mica and the like may usefully be included. For example, the polyamide can be used neat as a 100% solids hotmelt adhesive composition or combined with other components such as those mentioned previously herein to provide a formulated hotmelt adhesive composition. The polyamide can be utilized in combination with other polymers, particularly other thermoplastic polymers.

Polyamides of the present invention exhibit desirable high temperature properties, together with melting and thermal degradation temperatures making them well suited for melt processing and fabricating in injection molding and extrusion operations. The polyamides and compositions formulated therewith are useful in a variety of applications, including, for example, coatings, adhesives, sealants, films and laminates and can be formed into various articles including, for example, fibers, filaments, pellets, rods, webs, films, composites and the like. The polyamides are very well suited for use as or in adhesives for bonding substrates together including, for example, the pleats of a filter (e.g., an air filter, water filter, oil filter, or fuel filter) that may be exposed to or contacted with organic substances such as fuels, hydraulic fluids, oils or so forth.

A hot melt adhesive containing a polyamide according to the invention can used for bonding substrates by application in the form of a melt, using any of the application techniques known in the hot melt adhesive art, and by setting on cooling to room temperature. Such a hot melt is generally solid at 20° C. and is free of any solvents. A hot melt adhesive in accordance with the present invention may be utilized in any of the joining techniques known in the hot melt adhesive art. For example, a portion of the hot melt adhesive may be applied to a surface of a first substrate at a temperature effective to soften or melt the adhesive, wherein the tackiness of the heated hot melt adhesive allows the adhesive to stick to the substrate surface. While the adhesive is still warm and tacky, a surface of a second substrate may be brought into contact with the adhesive portion, with the second substrate surface also sticking to the adhesive portion. As the adhesive portion positioned between the substrate surfaces cools and resolidifies, an adhesive bond is thereby formed between the two substrates. Alternatively, the adhesive portion initially applied to the first substrate surface may be cooled and resolidified, then reheated (reactivated) prior to or simultaneous with bringing the second substrate surface into contact with such adhesive portion. In yet other embodiment, an adhesive portion in solid form may be positioned between two substrates and then heated to a temperature effective to soften or melt the adhesive portion, causing it to bond together the substrates.

### EXAMPLES

Polyamides in accordance with the invention were prepared by reacting the materials shown in Table 1. The amounts used of each material are stated in parts by weight. In each case, the amine component comprised 84 equivalent % hexamethylene diamine, 10 equivalent % JEFFAMINE D400 polyoxyalkylene diamine, and 6 equivalent % XT7-542 diamine. The properties of the polyamides thereby obtained are shown in Table 2.

TABLE 1

| | Ex. 1 | Ex. 2 | Ex. 3 | Ex. 4 | Ex. 5 | Ex. 6 | Ex. 7 |
|---|---|---|---|---|---|---|---|
| 1,10-Decanedioic | 44.89 | 44.99 | 45.12 | — | — | — | — |
| acid | | | | | | | |
| 1,12-Dodecanedioic | — | — | — | 48.11 | — | — | — |
| acid | | | | | | | |
| 1,14-Tetradecane- | — | — | — | — | 50.92 | 51.00 | 50.43 |
| dioic acid | | | | | | | |
| Stearic Acid | — | — | — | — | — | — | 0.67 |
| Hexamethylene- | 29.93 | 29.87 | 29.80 | 28.11 | 26.53 | 26.48 | 26.43 |
| diamine (70%) | | | | | | | |
| JEFFAMINE D400¹ | 9.88 | 9.87 | 9.84 | 9.29 | 8.76 | 8.75 | 8.73 |
| XTJ-542² | 13.28 | 13.25 | 13.22 | 12.47 | 11.77 | 11.75 | 11.73 |
| NAUGARD 445³ | 2.00 | 2.00 | 2.00 | 2.00 | 2.00 | 2.00 | 2.00 |
| Phosphoric Acid | 0.02 | 0.02 | 0.02 | 0.02 | 0.02 | 0.02 | 0.02 |

TABLE 2

| | Ex. 1 | Ex. 2 | Ex. 3 | Ex. 4 | Ex. 5 | Ex. 6 | Ex. 7 |
|---|---|---|---|---|---|---|---|
| Visc. at | 122 | 86 | 55 | 86 | 131 | 92 | 55 |
| 225° C., P⁴ | | | | | | | |
| Softening | 217 | 217 | 216 | 211 | 207 | 207 | 206 |
| Point, ° C.⁵ | | | | | | | |
| 2% Modulus, | 35,700 | 36,170 | 35,100 | 46,340 | 44,710 | 47,880 | 46,740 |
| psi⁶ | | | | | | | |
| Elongation, | 365 | 383 | 377 | 310 | 340 | 340 | 164 |
| %⁷ | | | | | | | |
| UTS, %⁸ | 4570 | 4705 | 4306 | 4045 | 4320 | 4270 | 2367 |
| Yield Point, | 1793 | 1946 | 1774 | 1990 | 2050 | 2160 | 2036 |
| psi⁹ | | | | | | | |
| Shore D | 73 | 75 | 73 | 75 | 73 | 73 | 72 |
| Hardness¹⁰ | | | | | | | |
| Biodiesel | Excellent | Excellent | Excellent | Excellent | Excellent | Excellent | Excellent |
| Resistance¹¹ | | | | | | | |
| Gas./Meth. | Excellent | Excellent | Excellent | Excellent | Excellent | Excellent | Excellent |
| Resistance¹² | | | | | | | |
| E85 Fuel | Excellent | Excellent | Excellent | Excellent | Excellent | Excellent | Excellent |
| Resistance¹³ | | | | | | | |
| SKYDROL | Excellent | Excellent | Excellent | Good | Good | Good | Good |
| Resistance, | | | | | | | |
| 10 days¹⁴ | | | | | | | |
| SKYDROL | Good | Good | No | No | No | No | No |
| Resistance, | | | Crack/Brt. | Crack/Brt. | Crack/Brt. | Crack/Brt. | Crack/Brt. |
| 20 days¹⁴ | | | | | | | |
| SKYDROL | Med.- | Med.- | No | No | No | No | No |
| Resistance, | Good | Good | Crack/Brt. | Crack/Brt. | Crack/Brt. | Crack/Brt. | Crack/Brt. |
| 30 days¹⁴ | | | | | | | |
| Mandrel | −40 | −35 | −25 | −25 | −25 | −25 | −15 |
| Test¹⁵ | | | | | | | |
| Temp. Cr. | >200 | >200 | >200 | >200 | >200 | >200 | >200 |
| Resistance¹⁶ | | | | | | | |

¹polyoxypropylene diamine having a number average molecular weight of about 400, supplied by Huntsman Corporation
²polyoxyalkylene diamine containing center block of about 9 oxytetramethylene groups on average and 2-3 oxypropylene groups on average on either side of the center block, number average molecular weight about 1000, supplied by Huntsman Corporation
³antioxidant, supplied by Chemtura Corporation (formerly Crompton)
⁴ASTM D3236-88, spindle 27
⁵ASTM E28-99
⁶ASTM D638-00
⁷ASTM D638-00
⁸ultimate tensile break, ASTM D638-00
⁹ASTM D638-00
¹⁰ASTM D2240-85
¹¹7 day immersion of 50 mil specimens at room temperature
¹²gasoline/methanol mixture (8/2), 7 day immersion of 50 mil specimens at room temperature
¹³gasoline/ethanol (15/85), 7 day immersion of 50 mil specimens at room temperature
¹⁴immersion of 50 mil specimens at 190° F./88° C. for the number of days indicated; SKYDROL is a phosphate ester-based hydraulic fluid sold by Solutia; “No Crack/Brt.” = no crack was noticed, but the specimen was brittle under stress (upon bending)
¹⁵tested in accordance with method developed by assignee/applicant
¹⁶temperature creep resistance, tested in accordance with method developed by assignee/applicant, using 3 lb load in a programmable oven, heating rate = 1° C./min

What is claimed is:

1. A polyamide which is the reaction product of a) an acid component comprising at least one C₆ to C₂₂ aliphatic dicarboxylic acid and b) an amine component comprising at least one alkylene diamine having from 2 to 14 carbon atoms, at least one polyoxyalkylene diamine containing at least one polyoxytetramethylene block, and at least one polyoxyalkylene diamine that does not contain a polyoxytetramethylene block.

2. A polyamide according to claim 1 wherein the acid component comprises at least one C8 to C18 linear aliphatic dicarboxylic acid.

3. A polyamide according to claim 1 wherein the acid component comprises at least one C10 to C14 linear aliphatic dicarboxylic acid.

4. A polyamide according to claim 1 wherein the acid component comprises at least 80 equivalent % of at least one C8 to C18 linear aliphatic dicarboxylic acid.

5. A polyamide according to claim 1 wherein the acid component comprises at least 90 equivalent % of at least one C10 to C14 linear aliphatic dicarboxylic acid.

6. A polyamide according to claim 1 wherein the amine component comprises at least one alkylene diamine having from 4 to 8 carbon atoms.

7. A polyamide according to claim 1 wherein the amine component comprises hexamethylenediamine.

8. A polyamide according to claim 1 wherein said at least one polyoxyalkylene diamine that contains at least one polyoxytetramethylene block has a number average molecular weight of from about 500 to about 2000.

9. A polyamide according to claim 1 wherein said at least one polyoxyalkylene diamine that contains at least one polyoxytetramethylene block has a number average molecular weight of from about 800 to about 1500.

10. A polyamide according to claim 1 wherein said at least one polyoxyalkylene diamine that contains at least one polyoxytetramethylene block has a central polyoxytetramethylene block and oxypropylene end groups.

11. A polyamide according to claim 1 wherein the amine component comprises at least one polyoxyalkylene diamine prepared by polymerizing one or more C₂ to C₄ epoxides to form a polyether polyol having hydroxyl end-groups and converting the hydroxyl end-groups to amine groups.

12. A polyamide according to claim 1 wherein the amine component comprises at least one polyoxypropylene diamine having a number average molecular weight of from about 200 to about 600.

13. A polyamide according to claim 1 wherein the amine component is comprised of 75 to 94 equivalent % alkylene diamine having from 2 to 10 carbon atoms, 1 to 10 equivalent % polyoxyalkylene diamine containing at least one polyoxytetramethylene block, and 5 to 15 equivalent % polyoxyalkylene diamine that does not contain a polyoxytetramethylene block.

14. A polyamide according to claim 1 wherein the equivalent ratio of C₂-C₁₄ alkylene diamine to polyoxyalkylene diamine is from about 3:1 to about 8:1.

15. A polyamide comprised of repeating moieties A, B, C and D, wherein:
a). moiety A has general structure —C(═O)—R—C(═O)—, wherein R is an aliphatic hydrocarbon radical containing from 4 to 20 carbon atoms;
b). moiety B has general structure —NH—(CH₂)ₙ—NH—, wherein n is 2 to 14;
c). moiety C has general structure —NH—X—Y—X¹—NH—, wherein X and X¹ are the same or different and are comprised of one or more oxyalkylene groups selected from the group consisting of oxyethylene, oxypropylene and combinations thereof and Y is comprised of a plurality of oxytetramethylene groups; and
d). moiety D has general structure —NH—X²—NH—, wherein X² is comprised of oxyalkylene groups selected from the group consisting of oxyethylene, oxypropylene and combinations thereof.

16. A method of bonding a first substrate to a second substrate, said method
comprising heating an adhesive composition comprising a polyamide in accordance with claim 1 to a temperature effective to render said adhesive composition tacky, placing at least a portion of said adhesive composition between said first substrate and said second substrate, and cooling said adhesive composition.
